(19) United States
(12) Patent Application Publication
(10) Pub. No.: US 2005/0046050 A1
(43) Pub. Date: Mar. 3, 2005

(54) Evaporative cooling system with flexible media

(75) Inventors: Roger C. Palmer, Scottsdale, AZ (US); Donald L. Townsend, Phoenix, AZ (US)

Correspondence Address: FOLEY & LARDNER, 777 EAST WISCONSIN AVENUE, SUITE 3800, MILWAUKEE, WI, 53202-5308, US

(73) Assignee: AbobeAir, Inc.

(21) Appl. No.: 10/932,767

(22) Filed: Sep. 2, 2004

Related U.S. Application Data
(60) Provisional application No. 60/499,562, filed on Sep. 2, 2003.

(51) Int. Cl. B01F 3/04

(52) U.S. Cl. 261/97; 261/99; 261/DIG. 3; 261/DIG. 43

(57) ABSTRACT

A media pad for an evaporative cooler includes a plurality of superposed sheets of slit and expanded wicking paper joined together. A pressure drop across the media pad is less than about 0.25 inches of water at an air speed of 225 feet per minute and at about room temperature. A means for providing capillary dispersion of water having a Klemm greater than about 3 inches in 10 minutes is also disclosed. An evaporative cooling system including a housing having with an evaporative media pad that is flexible is also disclosed.

### CROSS-REFERENCE TO RELATED PATENT APPLICATIONS

This application is an application claiming the benefit under 35 USC 119(e) U.S. application No. 60/499,562, filed Sep. 2, 2003, incorporated herein by reference in its entirety.

### BACKGROUND OF THE INVENTION

Evaporative coolers are well know and used in warm climates to cool the air. Conventional evaporative coolers work by drawing air from outside through a rigid media soaked with water. As the air flows through the media soaked with water, the water is evaporated by the outside air thereby lowering the temperature of the air. The cooled air is then directed into the area to be cooled.

Conventional evaporative coolers include a number of elements stored in a housing. These elements typically include an air blower, a media pad, a water distribution system, and an electric motor. One type of conventional media pad for an evaporative cooler includes aspenwood excelsior. However, such aspenwood excelsior is subject to degradation and has a relatively short useful life.

Another type of conventional media pad for an evaporative cooler include a cross-corrugated, rigid, non-perforated pad. However, such conventional media pads for evaporative coolers are relatively expensive.

Humidifiers are also well known. Humidifiers supply moisture to the air and maintain desired humidity conditions. Humidifiers typically include a number of elements including a humidifier pad. Conventional humidifier pads include superposed sheets or layers of perforated material which are wetted. A relatively low flow of air is directed into such conventional humidifier pads to cause evaporation of the water. The evaporated water is carried off in the air passing through the humidifier. However, such conventional humidifier pads do not allow for sufficient air flow through the pad sufficient to significantly lower the temperature of the air as do media pads of conventional evaporative coolers.

Accordingly, it would be desirable to provide in an evaporative cooler a media pad of the type conventionally used in a humidifier that has substantial wicking characteristics and also allows for sufficient air flow through the pad(s), for example 3000 cubic feet per minute. Additionally, it would be desirable to provide a media pad for an evaporative cooler that has surfaces that spread water rapidly. Further, it would be desirable to provide a media pad for an evaporative cooler that allows for sufficient air flow through the pad to lower the temperature of the air. It would also be desirable to provide a media pad for an evaporative cooler that has a longer useful life than conventional aspenwood excelsior pads. It would also be desirable to provide a media pad for an evaporative cooler that has a lower cost than conventional cross-corrugated, rigid non-perforated pads. It would still further be desirable to an evaporative cooling system with flexible media having one or more of these or other advantageous features.

### SUMMARY OF THE INVENTION

A first embodiment relates to a media pad for an evaporative cooler. The media pad includes a plurality of superposed sheets of slit and expanded wicking paper joined together. A pressure drop across the media pad is less than about 0.25 inches of water at an air speed of 225 feet per minute and at about room temperature.

The first embodiment wherein a pressure drop across the media pad is less than about 0.17 inches of water at an air speed of 225 feet per minute and at room temperature.

The first embodiment further comprising a plurality of sheets of slit and expanded substantially nonwicking paper.

The first embodiment wherein a major surface of at least one of the sheets of nonwicking paper is interposed in parallel relationship between, and coupled to, a major surface at least one of the sheets of wicking paper.

The first embodiment wherein the major surface of each of the sheets of nonwicking paper is disposed in contact with the major surface of one of the sheets of wicking paper.

The first embodiment wherein the sheets of wicking paper comprise at least about one-third of the total number of sheets of wicking paper and sheets of nonwicking paper.

The first embodiment wherein the sheets of wicking paper comprise between about one-half to about three-quarters the total number of sheets of wicking paper and sheets of nonwicking paper.

The first embodiment wherein the sheets of wicking paper comprise moisture absorbent paper.

A second embodiment relates to a media pad for an evaporative cooler. The media pad includes means for providing capillary dispersion of water. The media pad also includes means for providing the flow of air through the means for providing capillary dispersion of water. The means for providing capillary dispersion of water has a Klemm greater than about 3 inches in 10 minutes.

The second embodiment wherein the means for providing capillary attraction has a Klemm greater than about 6 inches in 10 minutes.

The second embodiment wherein the means for providing the flow of air provides a pressure drop of less than about 0.2 inches of water at room temperature and an air speed of 225 feet per minute.

The second embodiment wherein the means for providing capillary attraction comprises paper that is water absorbing.

The second embodiment wherein the means for providing capillary attraction comprises wicking paper.

The second embodiment wherein the means for providing the flow of air comprises a plurality of openings in, the wicking paper.

The second embodiment wherein the openings have a generally diamond shape.

A third embodiment relates to an evaporative cooling system. The evaporative cooling system includes a housing having with an evaporative media pad that is flexible. The evaporative cooling system also includes a water circulation system configured to disperse water over the evaporative medium pad. A first portion of the pad is wetted by the water circulation system so that the water is dispersed to a second portion of the pad.

The third embodiment wherein the first portion is an upper portion.

The third embodiment wherein the second portion is a lower portion.

The third embodiment wherein the evaporative media pad comprises paper that is water absorbing.

The third embodiment wherein the evaporative media pad comprises wicking paper.

The third embodiment wherein the moisture absorbent paper has a Klemm greater than about 3 inches in 10 minutes.

The third embodiment wherein the moisture absorbent paper has a Klemm greater than about 6 inches in 10 minutes.

The third embodiment wherein the moisture absorbent paper comprises openings sufficient to provide a pressure drop of less than about 0.2 inches of water at room temperature and an air speed of 225 feet per minute.

### BRIEF DESCRIPTION OF THE DRAWINGS

FIG. 1 is a perspective view of a media pad for an evaporative cooling system according to a preferred embodiment.

FIG. 2 is an exploded perspective view of the media pad of FIG. 1 according to an alternative embodiment.

FIG. 3 is a fragmentary perspective view of the media pad of FIG. 1 showing a detail of area 3 of FIG. 2.

FIG. 4 is a perspective view of an evaporative cooling system according to an exemplary embodiment.

FIG. 5 is a sectional view of the evaporative cooling system of FIG. 4 according to an exemplary embodiment.

### DETAILED DESCRIPTION OF THE PREFERRED EMBODIMENTS

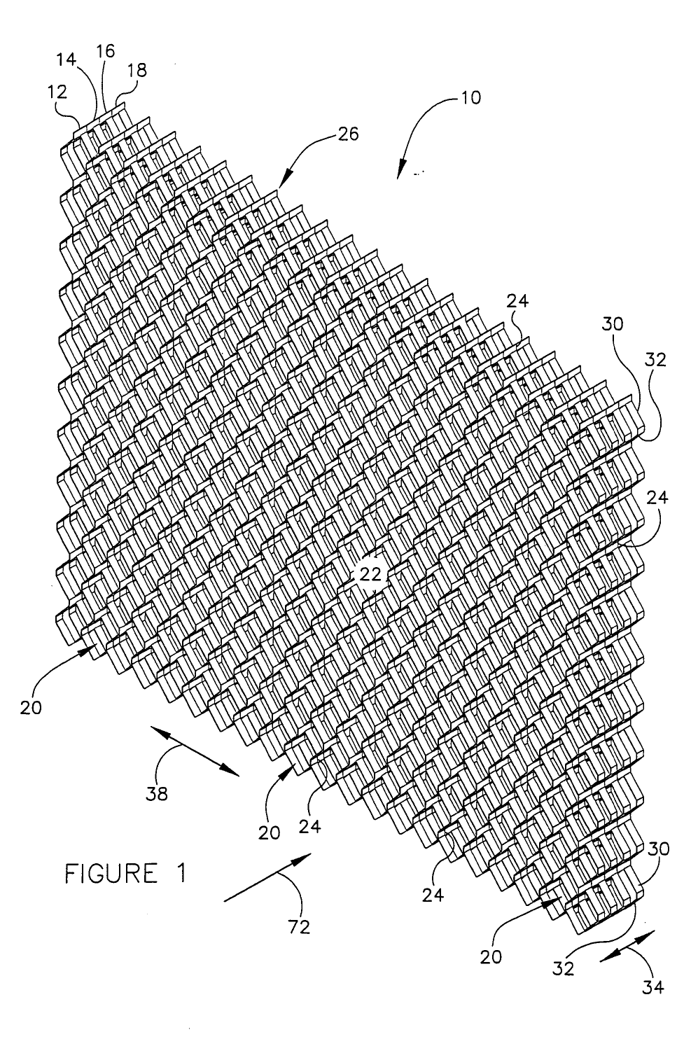

Referring to FIG. 1, a media pad 10 is shown according to a preferred embodiment. Media pad 10 is similar to the type of humidifier pads as shown and described in U.S. Pat. No. 6,110,564 titled “Evaporative Humidifier Pad” issued to Jeffrey S. Pontius on Aug. 29, 2000 and assigned to Columbus Industries, Inc. of Ashville, Ohio, which is hereby incorporated by reference.

Media pad 10 is modified from the humidifier pads of the '564 patent in at least two respects: (1) superposed layers or sheets 12, 24, 16 and 18 of media pad 10 have opening or apertures 20 that allow for sufficient flow of air through media pad 10 (such as 3000 cubic feet per minute for the media pads in an evaporative cooler) to provide a suitable cooling effect; and (2) media pad 10 having sheets 12, 14, 16 and 18 in the evaporative cooler provide for sufficient cooling (rather than humidification) of the air. Other than these modifications, the construction and performance of media pad 10 is similar to that of the humidifier pad of the '564 patent.

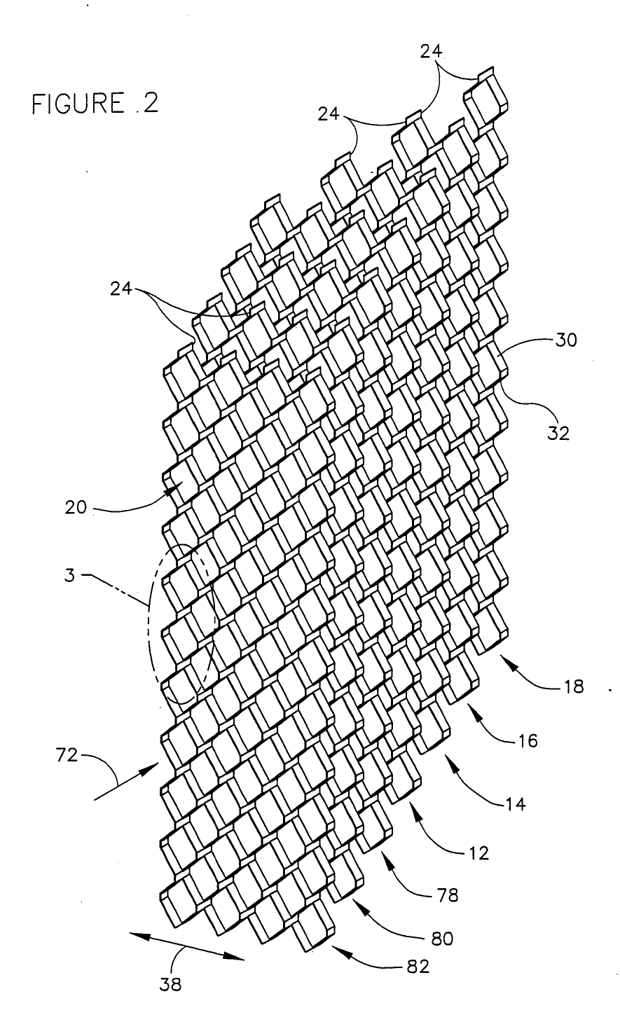

Referring to FIG. 1, media pad 10 is shown having layers of sheets 12, 14, 16 and 18. A major surface 22 of each of the sheets is attached to the major surface of an adjacent sheet in a parallel relationship by a fastener shown as a spot or layer of glue 24 according to a preferred embodiment. Media pad 10 may include multiple sheets offset from one another and shown as sheets 78, 80 and 82 in FIG. 2 according to an alternative embodiment. Each of sheets 12, 14, 16 and 18 may include a reinforcing member shown as a tape 26 in FIG. 1 according to an alternative embodiment.

Sheets 12 and 16 are moisture absorbent or wicking paper according to a preferred embodiment. Sheets 14 and 18 are substantially nonwicking paper according to a preferred embodiment. The ratio of wicking sheets to nonwicking sheets in the media pad is greater than about 30 percent, more suitable greater than about 50 percent of the total number of paper sheets (e.g. 8 wicking sheets and 8 non-wicking sheets) according to one embodiment. In another embodiment, the ratio of wicking sheets to nonwicking sheets in the media pad is less than about 75 percent of the total number of paper sheets (e.g. about 12 nonwicking sheets interposed between and among about 16 nonwicking sheets). According to one embodiment, the media pad has 10 wicking sheets and 6 non-wicking sheets. According to other alternative embodiments, the media pad may comprise only wicking sheets or only non-wicking sheets of any combinations thereof.

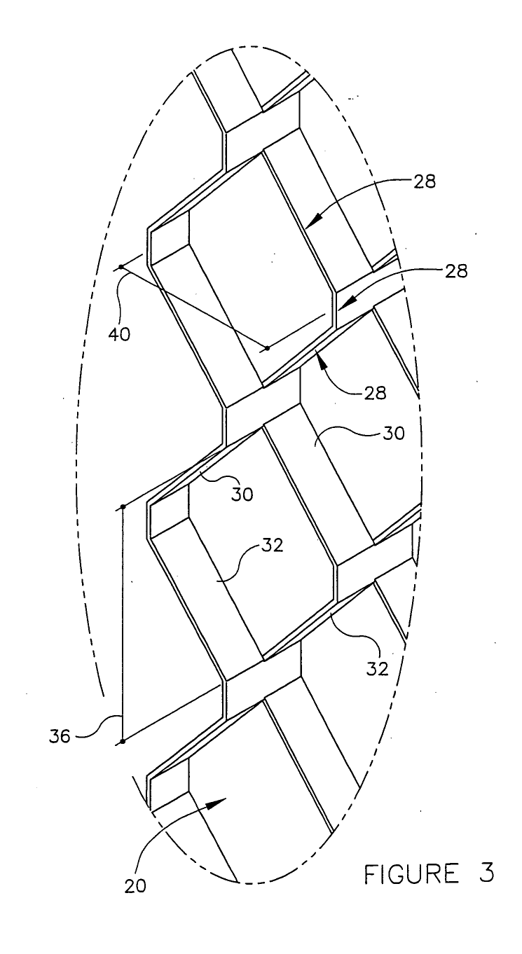

To manufacture the sheets, a cut or perforation shown as a slit edge 28 in FIG. 3 is made in major surface 22 of the sheet along an edge or leg 30 and a leg 32. Each of sheets 12, 14, 16 and 18 are then expanded or moved apart from one another (e.g. in the direction of an arrow 38 as shown in FIG. 2). Aperture 20 comprises a means for providing the flow of air through the paper and has a square or diamond shape according to a preferred embodiment as shown in FIGS. 1 through 3. Thus, the media pad is flexible and bendable (which may assist in quick and easy installation of the media pad in the evaporative cooler) according to a preferred embodiment in comparison with the rigid, corrugated cardboard sheets of standard rigid media. According to an alternative embodiment, the pad may be partially rigidified by a rigidifying material such as plastic.

Referring to FIG. 3, aperture 20 has a major diameter 36 and a minor diameter 40. The length of major diameter 36 and the length of minor diameter 40 varies depending on the distance each sheet is spread in the direction shown by arrow 38 in FIG. 2 according to a preferred embodiment. According to one embodiment, the major diameter of the aperture is about 0.8 inches. According to a preferred embodiment, the major diameter of the aperture is about 0.875 inches. According to one embodiment, the minor diameter of the aperture is greater than about 0.25 inches. According to another embodiment, the minor diameter of the aperture is greater than about 0.5 inches. According to a preferred embodiment, the minor diameter of the aperture is greater than about 0.75 inches.

According to a preferred embodiment, the airflow through the pad is in the direction normal to the major surface of the sheet shown in the direction of an arrow 72 in FIG. 2. The airflow through the pad is accomplished by directing the air through the apertures. The ease of airflow through the pad may also be adjusted by varying the alignment of the apertures of adjacent sheets according to alternative embodiments. For example, the legs of one sheet may at least partially block the airflow through the aperture of another sheet. A mounting interface such as a brace may be attached to the major surface or edge of the outer sheets (such as sheet 12 and sheet 18) to pull or space the sheets apart from one another in the direction shown by arrow 338 in FIG. 2 to regulate the spacing between the sheets and to increase or decrease airflow according to any preferred or alternative embodiments.

It is desirable to maximize the airflow through the media pad to provide sufficient evaporation of the water for the evaporative cooler. It is also desirable to minimize the change in pressure of the flow of air (e.g. at about 200 to 300 feet per minute) through the media pad. As used in this disclosure, the term “pressure drop” means and includes the change in the pressure of the flow of air as it enters the media pad at room temperature and as it exits the media pad (i.e. the static pressure difference between the air inlet side and the air outlet side of the media pad). The pressure drop is relatively small due in part to the size and/or alignment of the apertures of the media pad. Very low pressures are generally expressed in inches of water (rather than pounds-force/square inch, pounds per square inch or psi).

A manometer may be used to measure such pressure drop across the media pad according to a preferred embodiment. A manometer is a pressure gauge or instrument for comparing the pressure of gasses. A manometer operates on the principle of allowing gas to exert its elastic force in raising a column of liquid (e.g. mercury, water, etc.) in an open tube. A conventional manometer includes a U-shaped tube with water in it, and as pressure is applied to one side of the tube the water rises in the other side of the tube and the pressure reading is provided in inches of water.

According to one embodiment, the pressure drop across the media pad of a flow of air entering the media pad at about 225 feet per minute at about room temperature is less than about 0.8 inches of water (e.g. about 0.0289018 psi). According to another embodiment, the pressure drop across the media pad of a flow of air entering the media pad at about 225 feet per minute at about room temperature is less than about 0.7 inches of water (e.g. about 0.0252891 psi). According to another embodiment, the pressure drop across the media pad of a flow of air entering the media pad at about 225 feet per minute at about room temperature is less than about 0.31 inches of water (e.g. about 0.0111995 psi). According to another embodiment, the pressure drop across the media pad of a flow of air entering the media pad at about 225 feet per minute at about room temperature is less than about 0.26 inches of water (e.g. about 0.0093931 psi). According to another embodiment, the pressure drop across the media pad of a flow of air entering the media pad at about 225 feet per minute at about room temperature is less than about 0.17 inches of water (e.g. about 0.0061416 psi). According to another embodiment, the pressure drop across the media pad of a flow of air entering the media pad at about 225 feet per minute at about room temperature is less than about 0.015 inches of water (e.g. about 0.0054191 psi). According to a preferred embodiment, the pressure drop across the media pad of a flow of air entering the media pad at about 225 feet per minute at about room temperature is less than about 0.13 inches of water (e.g. about 0.0046965 psi).

The size of the apertures of the sheets of the media pad also defines in part the “evaporative efficiency” of the evaporative cooler having the media pad. The term “evaporative efficiency,” is also known as cooling or saturating efficiency or effectiveness. Evaporative efficiency is a rating of the performance of the evaporative cooler. Evaporative efficiency is conventionally calculated as follows:

$${E}_{s} = 1 - \frac{{t}_{2} - {t}_{3}}{{t}_{1} - {t}_{3}} \times 100$$

where Eₛ=saturating efficiency, percent
t₁=entering air dry-bulb temperature
t₂=leaving air dry-bulb temperature
t₃=entry air wet-bulb temperature.

Note, the term “dry bulb temperature” refers to the air temperature as measured by ordinary bare thermometers and the term “wet-bulb temperature” refers to thermometers whose bulbs are covered by wetted wicks exposed to rapidly moving air. See Watt et al., EVAPORATIVE AIR CONDITIONING HANDBOOK, 12-22 (Fairmont Press, Inc. 1997); see also ANSI/ASHRAE Standard No. 133-2001 titled “Method of Testing Direct Evaporative Air Coolers” by the American Society of Heating, Refrigeration and Air-Conditioning Engineers, Inc. bearing a designation of “2/02,” which are hereby incorporated by reference.

According to a preferred embodiment, the evaporative efficiency of the evaporative cooler having the flexible media pad(s) is greater than about 50 percent, suitably greater than about 60 percent. According to a preferred embodiment, the airflow across the media pad (e.g. about 3 to 4 flexible media pads of the evaporative cooler) is about 3000 cubic feet per minute.

According to a preferred embodiment, the wicking sheets of the media pad have a Klemm or capillary rise of greater than about 1.75 inches. The term “capillary rise” of water in paper as used in this disclosure means and includes the distance water rises in a strip of paper suspended vertically with its lower end immersed in water. The Klemm method is described in “Capillary Rise in Paper and Paperboard by the Klemm Method” SCAN testing method no. SCAN-P13: 64 (accepted June 1964), which is hereby incorporated by reference.

The capillary rise in paper sheet samples for various media pads were tested according to the Klemm method. The samples were each 6 inches tall. The samples were maintained in water for 10 minutes. The results of the capillary rise observed in the samples are shown in TABLE I.

TABLE I

| Sample | Height (inches) |
|---|---|
| GLACIER CORE rigid media paper | 0.3125 |
| commercially available from Munters | |
| Corporation of Fort Myers, Florida | |
| MASTER COOL rigid media paper | 1.750 |
| commercially available from Munters | |
| Corporation of Fort Myers, Florida | |
| Flexible wicking paper available from | 6.000+ |
| Columbus Industries, Inc. of Ashville, | |
| Ohio | |

As can be seen from TABLE 1, the flexible wicking paper has a greater Klemm or capillary rise than the rigid media paper(s).

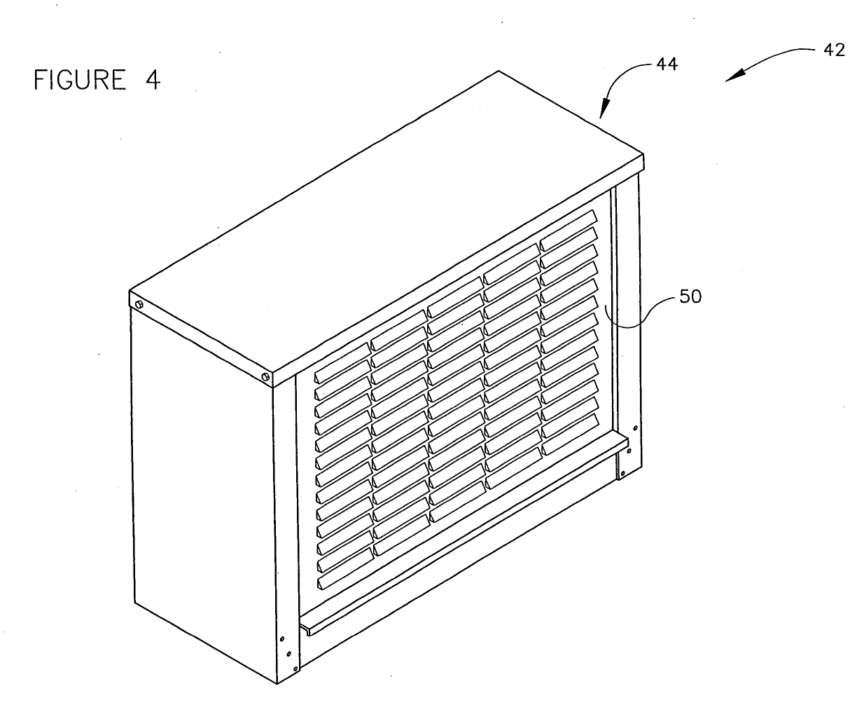

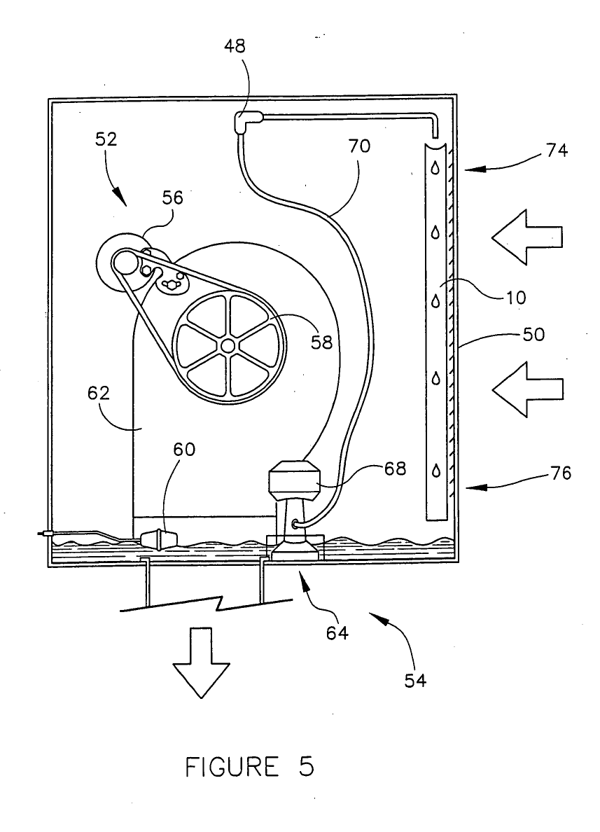

Referring to FIGS. 4 and 5, an evaporative cooler unit 42 is shown according to an exemplary embodiment. Evaporative cooler 42 includes a casing or housing 44. Referring to FIG. 5, a water distribution network 48 disperses water over the vertically upright evaporative media pad 10. A fan or blower 62 draws exterior air through an air intake or louver vent 50 and through pad 10 soaked with water (see FIGS. 4 and 5). The temperature of the exterior air is reduced or cooled due to evaporation of the water in the media pad.

Referring further to FIG. 5, the cooled air is blown out of housing 44 by blower 62. Blower 62 includes a motor 56 connected to a pulley 58 moving a circular fan for venting the cooled air to a desired location such as a work or residential space. The evaporative cooler includes a wet chamber according to a preferred embodiment, and may include a dry chamber that is intended to be substantially free of water according to an alternative embodiment.

A water recirculation system 54 for recycling non-evaporated water back to pad 10 is shown in FIG. 5 according to an alternative embodiment. Recirculation system 54 includes a sensor shown as a float 60 for providing a signal representative of the volume or level of non-evaporated water. Recirculation system 54 also includes a pump assembly 64 having a water pump 68 connected to water distribution network 48 by a hose 70. Water distribution network 48 provides for the dispersion of the recycled as well as “original” or source water over the top of pad 10.

According to a preferred embodiment as shown in FIG. 5, pad 10 is wet with water which drains through pad from an upper portion 74 to a lower portion 76. According to a preferred embodiment, the media pad includes a water absorbent or wicking material such as Kraft paper. The wicking paper or means for providing capillary attraction provides for more movement of the water in the pad due to capillary attraction forces. According to a particularly preferred embodiment. The wicking paper is resistant to rapid degradation.

The evaporative cooling system may be placed outdoors as well as indoors according to any preferred or alternative embodiment. The evaporative cooling system is intended to be placed where there is an abundance of fresh air, and may be positioned adjacent to an open window or external door with additional openings on opposite sides of the room according to alternative embodiments. In this way, the evaporative cooling system may draw fresh air from the outside and be drawn through the pad, cooled, filtered and circulated through the room while the hot, stale air is forced out through the openings on the other side of the room.

The evaporative cooling system may be used in a variety of environments, including at least: industrial and commercial settings such as industrial plants, factories, assembly lines, warehouses, commercial kitchens, laundries, dry cleaners, greenhouses, confinement farming such as poultry ranches, hog, dairy, etc., retail outlets, garden centers, auto shops, hotels/resorts, etc., residential settings such as workshops, garages, kennels, horse stables, patios, barns, exercise areas, etc., outdoor settings such as loading docks, construction sites, athletic events, tented parties, sporting events, pools and patios, outdoor retail etc.

It is important to note that the construction and arrangement of the elements of the evaporative cooling system with flexible media as shown in the preferred and other exemplary embodiments is illustrative only. Although only a few embodiments of the present invention have been described in detail in this disclosure, those skilled in the art who review this disclosure will readily appreciate that many modifications are possible (e.g. variations in sizes, dimensions, structures, shapes and proportions of the various elements, values of parameters, mounting arrangements, use of materials, orientations, etc.) without materially departing from the novel teachings and advantages of the subject matter disclosed. Accordingly, all such modifications are intended to be included within the scope of the present invention. The order or sequence of any process or method steps may be varied or re-sequenced according to alternative embodiments. Other substitutions, modifications, changes and omissions may be made in the design, operating conditions and arrangement of the preferred and other exemplary embodiments without departing from the spirit of the present invention as expressed in this disclosure.

1. A media pad for an evaporative cooler, comprising:
a plurality of superposed sheets of slit and expanded wicking paper joined together; and
wherein the pressure drop across the media pad is less than about 0.25 inches of water at an air speed of 225 feet per minute.

2. The media pad of claim 1, wherein the pressure drop across the media pad is less than about 0.17 inches of water at an air speed of 225 feet per minute.

3. The media pad of claim 1, further comprising a plurality of sheets of slit and expanded substantially nonwicking paper.

4. The media pad of claim 3, wherein a major surface of at least one of the sheets of nonwicking paper is interposed in parallel relationship between, and coupled to, a major surface at least one of the sheets of wicking paper.

5. The media pad of claim 4, wherein the major surface of each of the sheets of nonwicking paper is disposed in contact with the major surface of one of the sheets of wicking paper.

6. The media pad of claim 5, wherein the sheets of wicking paper comprise at least about one-third of the total number of sheets of wicking paper and sheets of nonwicking paper.

7. The media pad of claim 6, wherein the sheets of wicking paper comprise between about one-half to about three-quarters the total number of sheets of wicking paper and sheets of nonwicking paper.

8. The media pad of claim 1 wherein the plurality of superposed sheets form are flexible and bendable.

9. A method for forming a media pad for an evaporative cooler, comprising:
providing capillary rise of water having a Klemm greater than 3 inches in 10 minutes; and
providing means for the flow of air through the means for providing capillary dispersion of water.

10. The method of claim 9, wherein providing capillary rise has a Klemm greater than about 6 inches in 10 minutes.

11. The method of claim 10, wherein the means for providing the flow of air provides a pressure drop of less than about 0.2 inches of water at room temperature and an air speed of 225 feet per minute.

12. The method of claim 11, wherein the means for providing capillary rise paper that is water absorbing.

13. The method of claim 12, wherein the means for providing capillary rise comprises wicking paper.

14. The method of claim 13, wherein the means for providing the flow of air comprises a plurality of openings in the wicking paper.

15. The method of claim 14, wherein the openings have a generally diamond shape and the means for providing capillary dispersion is flexible.

16. An evaporative cooling system comprising:
a housing having with an evaporative media pad that is flexible;
a water circulation system configured to disperse water over the evaporative medium pad; and
wherein a first portion of the pad is wetted by the water circulation system so that the water is dispersed to a second portion of the pad.

17. The evaporative cooling system of claim 16, wherein the first portion is an upper portion.

18. The evaporative cooling system of claim 16, wherein the second portion is a lower portion.

19. The evaporative cooling system of claim 16, wherein the evaporative media pad comprises paper that is water absorbing.

20. The evaporative cooling system of claim 16, wherein the evaporative media pad comprises wicking paper.

21. The evaporative cooling system of claim 16, wherein the moisture absorbent paper has a Klemm greater than about 3 inches in 10 minutes.

22. The evaporative cooling system of claim 16, wherein the moisture absorbent paper has a Klemm greater than about 6 inches in 10 minutes.

23. The evaporative cooling system of claim 16, wherein the moisture absorbent paper comprises openings sufficient to provide a pressure drop of less than about 0.2 inches of water at room temperature and an air speed of 225 feet per minute.
